(19) United States
(12) Patent Application Publication
(10) Pub. No.: US 2020/0395821 A1
(43) Pub. Date: Dec. 17, 2020

(54) ROTARY ELECTRIC MACHINE

(71) Applicant: HONDA MOTOR CO., LTD., Tokyo (JP)

(72) Inventors: Manabu Sakurada, Wako-shi (JP); Koji Kuroda, Wako-shi (JP)

(21) Appl. No.: 15/930,547

(22) Filed: May 13, 2020

(30) Foreign Application Priority Data
May 16, 2019 (JP) 2019-092819

(51) Int. Cl. H02K 9/193; H02K 5/20; H02K 11/20

(52) U.S. Cl. CPC H02K 9/193; H02K 11/20; H02K 5/20

(57) ABSTRACT

A rotary electric machine includes a stator, a rotor, a housing, a cooling liquid introduction room, and a lubricating liquid introduction room. The rotary electric machine further includes a first seal member, a second seal member, and a leakage liquid discharge hole. The first seal member regulates a leakage of the cooling liquid to a lubricating liquid introduction room direction from the cooling liquid introduction room. The second seal member regulates a leakage of the lubricating liquid to a cooling liquid introduction room direction from the lubricating liquid introduction room. The leakage liquid discharge hole is arranged between the first seal member and the second seal member. The leakage liquid discharge hole discharges the cooling liquid that is leaked through the first seal member and the lubricating liquid that is leaked through the second seal member to an outside of the housing.

### CROSS-REFERENCE TO RELATED APPLICATION

Priority is claimed on Japanese Patent Application No. 2019-092819, filed on May 16, 2019, the contents of which are incorporated herein by reference.

### BACKGROUND

### Field of the Invention

The present invention relates to a rotary electric machine mounted on a vehicle or the like.

### Background

As a rotary electric machine mounted on a vehicle or the like, such a machine is known which includes a rotor that is rotated integrally with a rotation shaft and a stator that is arranged radially outside the rotor, wherein a plurality of permanent magnets are arranged on an outer circumference of the rotor, and a coil is wound around the stator. In this type of rotary electric machine, a coil part of the stator easily generates heat during operation.

As a countermeasure, a rotary electric machine is proposed in which a cylindrical stator holder that holds a stator is fixed to an inner surface of a circumferential wall part of a housing by a press fit or the like, and a cooling liquid introduction room is formed between the housing and an outer circumferential surface of the stator holder (for example, refer to Japanese Unexamined Patent Application, First Publication No. 2007-202234).

The rotary electric machine described in Japanese Unexamined Patent Application, First Publication No. 2007-202234 can efficiently cool the heat of the stator due to a coil by allowing a cooling liquid to flow through the cooling liquid introduction room.

Further, in the rotary electric machine described in Japanese Unexamined Patent Application, First Publication No. 2007-202234, axially outer parts of the stator holder and stator are a lubricating liquid introduction room for supplying a lubricating liquid to a lubrication required area in the housing.

A seal member that regulates a leakage of the cooling liquid to a lubricating liquid introduction room direction from the cooling liquid introduction room and a leakage of the lubricating liquid to a cooling liquid introduction room direction from the lubricating liquid introduction room is provided between the stator holder and the housing.

### SUMMARY

In the rotary electric machine described in Japanese Unexamined Patent Application, First Publication No. 2007-202234, a possibility that a sealing performance of a seal member may be degraded due to aging degradation or the like is conceivable. In a case where the sealing performance is degraded, there is a concern that the cooling liquid inside the cooling liquid introduction room may be leaked to the lubricating liquid introduction room side, or, conversely, the lubricating liquid inside the lubricating liquid introduction room may be leaked to the cooling liquid introduction room side. However, the leakages of the cooling liquid and the lubricating liquid occur inside the housing, and therefore, it is difficult to detect these leakages from the outside at an early stage.

An aspect of the present invention provides a rotary electric machine that is capable of detecting a leakage of a cooling liquid from a cooling liquid introduction room and a leakage of a lubricating liquid from a lubricating liquid introduction room at an early stage.

A rotary electric machine according to an aspect of the present invention includes: a stator; a rotor that is rotated relative to the stator; a housing that is configured to accommodate the stator and the rotor; a cooling liquid introduction room which is provided inside the housing and to which a cooling liquid for cooling a heat generation part is introduced; and a lubricating liquid introduction room which is provided inside the housing and to which a lubricating liquid for lubricating a lubrication required area is introduced, the rotary electric machine further including: a first seal member that is configured to regulate a leakage of the cooling liquid to a lubricating liquid introduction room direction from the cooling liquid introduction room; a second seal member that is configured to regulate a leakage of the lubricating liquid to a cooling liquid introduction room direction from the lubricating liquid introduction room; and a leakage liquid discharge hole which is arranged between the first seal member and the second seal member and which is configured to discharge the cooling liquid that is leaked through the first seal member and the lubricating liquid that is leaked through the second seal member to an outside of the housing.

According to the above configuration, when the cooling liquid in the cooling liquid introduction room passes through the first seal member and is leaked, the leaked cooling liquid is discharged through the leakage liquid discharge hole to the outside of the housing. The cooling liquid discharged to the outside of the housing can be checked visually by an operator, by a sensor, or the like. Similarly, when the lubricating liquid in the lubricating liquid introduction room passes through the second seal member and is leaked, the leaked lubricating liquid is discharged through the leakage liquid discharge hole to the outside of the housing. In this case, the cooling liquid discharged to the outside of the casing can also be checked visually by an operator, by a sensor, or the like.

The stator may be held inside a circumferential wall part of the housing, the rotor may be arranged radially inside the stator and coaxially with the stator, the cooling liquid introduction room may be arranged between the circumferential wall part and the stator, the lubricating liquid introduction room may be arranged inside the circumferential wall part and axially outside the stator, the first seal member may be arranged at a position close to the cooling liquid introduction room inside the circumferential wall part, the second seal member may be arranged at a position close to the lubricating liquid introduction room inside the circumferential wall part, and the leakage liquid discharge hole may be formed to radially penetrate through a lower position of the circumferential wall part.

In this case, when the stator is heated by electric power distribution to the coil, the heat is cooled by the cooling liquid flowing through the cooling liquid introduction room on an outer circumferential side of the stator. When the lubricating liquid is introduced to the lubricating liquid introduction room that is positioned axially outside the stator, the lubricating liquid lubricates a lubrication required area such as a bearing in the housing and absorbs heat of a heat generation part including the lubrication required area. Further, the cooling liquid in the cooling liquid introduction room and the lubricating liquid in the lubricating liquid introduction room flow in contact with an inner surface of the circumferential wall part of the housing, and the leakages of the cooling liquid and the lubricating liquid are regulated by the first seal member and the second seal member, respectively, at the inner side of the circumferential wall part. In a case where the cooling liquid or the lubricating liquid is leaked from the first seal member or the second seal member, the leaked liquid is promptly discharged to the outside of the housing from the leakage liquid discharge hole that radially penetrates through the lower position of the circumferential wall part.

Accordingly, when the present configuration is employed, it is possible to efficiently cool the inside of the housing, and it is possible to detect the leakage of the cooling liquid or the lubricating liquid further promptly.

The first seal member and the second seal member may be arranged to be axially aligned and in contact with an inner circumferential surface of the circumferential wall part.

In this case, it is possible to simplify a structure of a seal part formed of the first seal member and the second seal member.

The rotary electric machine may further include a stator holder that has a substantially cylindrical shape and that holds the stator at an inner circumferential side, wherein the stator holder may be held in contact with an inner circumferential surface of the circumferential wall part, the stator holder and the circumferential wall part may constitute the cooling liquid introduction room, and the first seal member and the second seal member may be arranged in contact with the inner circumferential surface of the circumferential wall part and an outer circumferential surface of the stator holder.

In this case, by assembling the stator holder to the circumferential wall part of the housing by a press fit or the like in a state where the stator is attached to the stator holder, the first seal member and the second seal member can be easily arranged between the stator holder and the circumferential wall part.

A seal pair constituted of the first seal member and the second seal member may be arranged in a first region close to one end portion in an axial direction of the circumferential wall part and a second region close to another end portion in the axial direction of the circumferential wall part, and the leakage liquid discharge hole may be provided in each of the first region and the second region.

In this case, it is possible to detect the leakage of the cooling liquid or the lubricating liquid at an early stage in the first region and the second region on both sides in the axial direction of the circumferential wall part.

A leakage liquid flow-in room that communicates with the leakage liquid discharge hole may be provided outside the housing, and a sensor that is configured to detect an incoming leakage liquid may be arranged in the leakage liquid flow-in room.

In this case, when a leakage of the cooling liquid or the lubricating liquid occurs in either the first region or the second region, the leakage liquid passes through the leakage liquid discharge hole and flows into the leakage liquid flow-in room, and the leakage liquid is detected by the sensor. Accordingly, when the present configuration is employed, even if the leakage of the cooling liquid or the lubricating liquid occurs in any of the first region and the second region, the leakage of the cooling liquid or the lubricating liquid can be detected at an early stage by the sensor.

In the aspect of the present invention, the leakage liquid discharge hole is arranged between the first seal member that is configured to regulate the leakage of the cooling liquid and the second seal member that is configured to regulate the leakage of the lubricating liquid, and the leakage liquid discharge hole that discharges the cooling liquid and the lubricating liquid (leakage liquid) to the outside of the housing is formed between the first seal member and the second seal member. Therefore, when the aspect of the present invention is employed, by checking the leakage liquid discharged to the outside of the housing through the leakage liquid discharge hole visually by an operator, by the sensor, or the like, it is possible to detect the leakage of the cooling liquid or the lubricating liquid at an early stage.

### BRIEF DESCRIPTION OF THE DRAWINGS

FIG. 1 is a longitudinal cross-sectional view of a rotary electric machine according to an embodiment.

FIG. 2 is an enlarged cross-sectional view showing part of FIG. 1.

### DESCRIPTION OF THE EMBODIMENTS

Hereinafter, an embodiment of the present invention will be described with reference to the drawings.

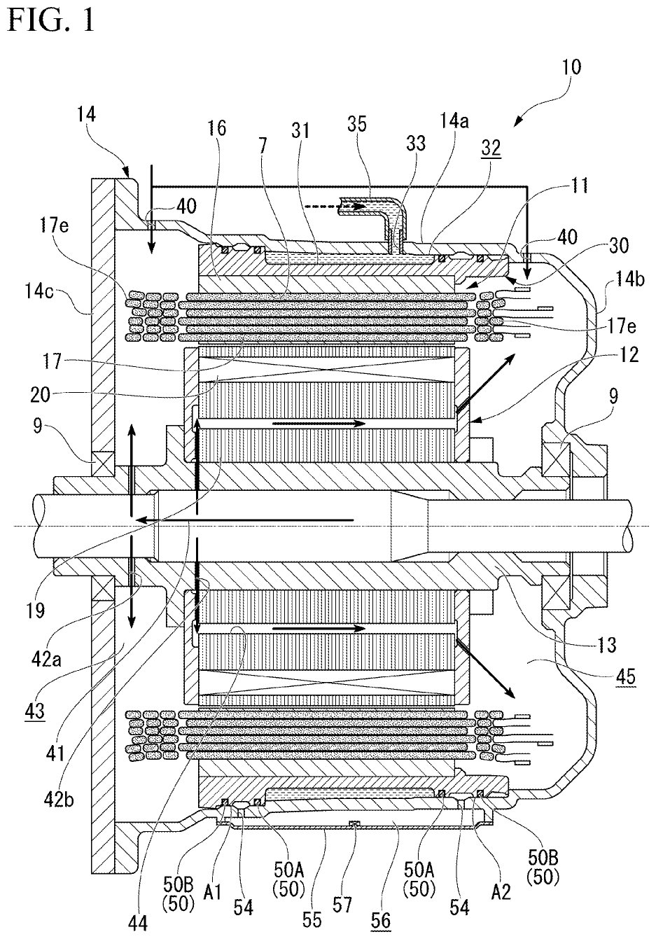

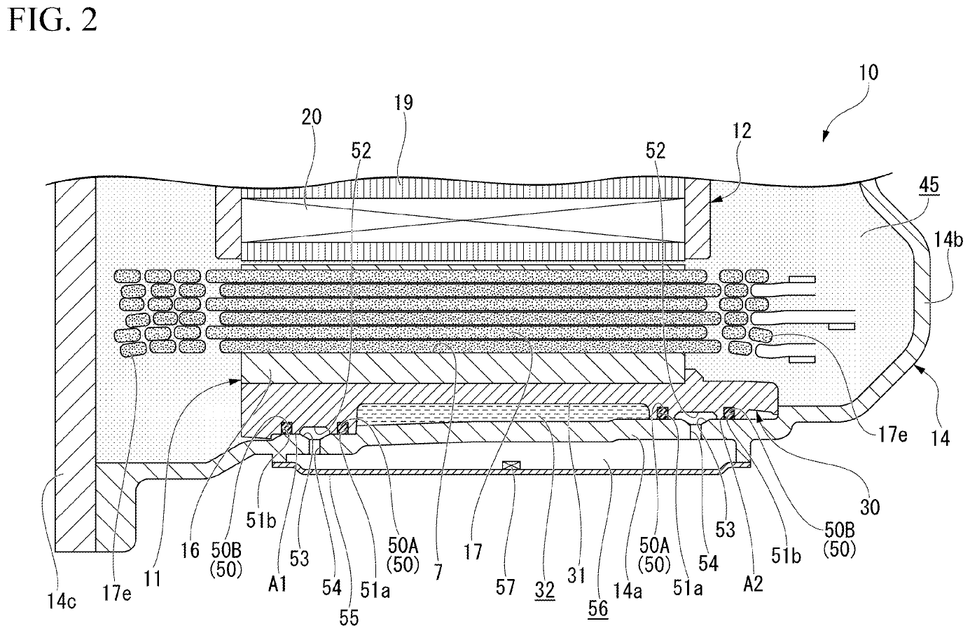

FIG. 1 is a longitudinal cross-sectional view showing a cross-section along an axial direction of a rotary electric machine 10 according to the present embodiment. FIG. 2 is an enlarged longitudinal cross-sectional view showing a lower end part of the rotary electric machine 10.

The rotary electric machine 10 of the present embodiment is used, for example, as a drive source of an electric vehicle. The rotary electric machine 10 includes a stator 11 that generates a rotation magnetic field, a rotor 12 that is rotated in response to the rotation magnetic field generated at the stator 11, a rotation shaft 13 that is coaxially provided on the rotor 12, and a housing 14 that internally holds the stator 11 and that covers outsides of the stator 11 and the rotor 12.

The stator 11 includes a stator core 16 having a substantially cylindrical shape and formed of a plurality of laminated electromagnetic steel plates and a coil 17 (electric power distribution coil) that is wound around an edge part on an inner circumferential side of the stator core 16. The coil 17 is constituted of a three-phase coil of the U phase, the V phase, and the W phase. The coil 17 of the present embodiment is constituted of segment coils that are mutually connected and used. The segment coil is constituted of a segment conductor having a pair of insertion parts inserted into a slot 7 of the stator core 16 and a folding connection portion that connects together the insertion parts. An end portion on the opposite side of the folding connection portion of the pair of insertion parts is a connection portion connected to another adjacent segment conductor.

In the coil 17, the connection portion of each segment conductor is arranged on one end side in the axial direction of the stator 11, and the folding connection portion is arranged on another end side in the axial direction of the stator 11. The connection portion and the folding connection portion protrude outward (is exposed to the outside) from each end part in the axial direction of the stator 11. An external electric power line is connected to the end part of the coil 17. A current is distributed to the coil 17 via the electric power line.

The rotor 12 includes a rotor core 19 integrally joined to an outer surface of the rotation shaft 13 and a plurality of permanent magnets 20 arranged on an outer circumferential edge part of the rotor core 19 to be spaced apart from each other in a circumferential direction. The rotor core 19 is formed in a substantially cylindrical form by laminating a plurality of electromagnetic steel plates. The rotation shaft 13 is rotatably supported by the housing 14 via a bearing 9. The rotor 12 is rotated in response to the rotation magnetic field of the stator 11, and thereby, the rotation shaft 13 is rotated integrally with the rotor 12.

The housing 14 includes a circumferential wall part 14a that covers an outer circumferential side of the stator core 16 and a pair of side wall parts 14b, 14c that are continuously connected to an end portion on axially both sides of the circumferential wall part 14a and that cover an axially outside part of the rotor 12 and a coil end 17e (an end part of the coil 17 exposed from an end surface in the axial direction of the stator 11) of the coil 17. A stator holder 30 having a substantially cylindrical shape is attached integrally to an outer circumferential surface of the stator core 16 of the stator 11. The stator holder 30 is fixed to the inner circumferential surface of the circumferential wall part 14a of the housing 14 by a press fit or the like. An annular groove 31 elongated in the axial direction is formed on an outer circumferential surface of the stator holder 30. The annular groove 31 of the stator holder 30 constitutes a cooling liquid introduction room 32 between the annular groove 31 and the circumferential wall part 14a in a state where the stator holder 30 is attached to the circumferential wall part 14a of the housing 14. The cooling liquid introduction room 32 is formed in a cylindrical shape substantially along the outer circumferential surface of the stator 11.

A flow-in port 33 for allowing the cooling liquid to flow into the cooling liquid introduction room 32 is formed on an upper side of the circumferential wall part 14a of the housing 14. A flow-out port (not shown) for allowing the cooling liquid to flow out from the cooling liquid introduction room 32 to the outside is formed on a lower side of the circumferential wall part 14a. An introduction piping 35 for introducing the cooling liquid from a pump (not shown) to the cooling liquid introduction room 32 is connected to the flow-in port 33. A return piping (not shown) for allowing the cooling liquid to return to the pump from the cooling liquid introduction room 32 is connected to the flow-out port.

Further, a lubricating liquid supply hole 40 for dropping the lubricating liquid to the coil end 17e of the coil 17 to cool the coil end 17e and then supplying the dropped lubricating liquid to a lubrication required area such as the bearing 9 is formed on an upper portion of the circumferential wall part 14a of the housing 14. The lubricating liquid supply hole 40 is formed on the circumferential wall part 14a at a position directly above the coil end 17e on one end side in the axial direction and at a position directly above the coil end 17e on another end side in the axial direction.

An in-shaft passage 41 is provided on the rotation shaft 13 along a shaft center of the rotation shaft 13. Branch passages 42a, 42b that allow the in-shaft passage 41 and an internal space of the housing 14 to communicate with each other is formed on the rotation shaft 13. One branch passage 42a communicates with a first lubricating liquid introduction room 43 (lubricating liquid introduction room) that faces one end side in the axial direction of the stator 11 and the rotor 12 in the housing 14. The other branch passage 42b communicates via an inner passage 44 of the rotor core 19 with a second lubricating liquid introduction room 45 (lubricating liquid introduction room) that faces another end side in the axial direction of the stator 11 and the rotor 12 in the housing 14. The in-shaft passage 41 of the rotation shaft 13 is connected to a supply device of the lubricating liquid. The lubricating liquid introduced into the in-shaft passage 41 is discharged through the branch passages 42a, 42b to the first lubricating liquid introduction room 43 and the second lubricating liquid introduction room 45.

The lubricating liquid introduced into the first lubricating liquid introduction room 43 and the second lubricating liquid introduction room 45 cools the rotor 12 and the stator 11 and is supplied to the lubrication required area in the housing 14 such as the bearing 9. The lubricating liquid dropped from each lubricating liquid supply hole 40 of the circumferential wall part 14a of the housing 14 is also introduced to the first lubricating liquid introduction room 43 and the second lubricating liquid introduction room 45. The lubricating liquid flowing into the first lubricating liquid introduction room 43 and the second lubricating liquid introduction room 45 returns to the supply device through a discharge passage (not shown) provided on the lower side of the housing 14.

A seal pair 50 constituted of a first seal member 50A and a second seal member 50B is assembled to an outer circumferential surface of the stator holder 30 at positions on both sides in the axial direction that sandwich the annular groove 31 (cooling liquid introduction room 32). Both the first seal member 50A and the second seal member 50B are formed in an annular shape and are in close contact with an inner circumferential surface of the circumferential wall part 14a in a state where the stator holder 30 is assembled to the inner circumferential surface of the circumferential wall part 14a of the housing 14. The first seal member 50A of each seal pair 50 is arranged at an axially inward position (at a position close to the cooling liquid introduction room) of the stator holder 30. The second seal member 50B of each seal pair 50 is arranged at an axially outward position (at a position close to the lubricating liquid introduction room) of the stator holder 30. The first seal member 50A and the second seal member 50B of each seal pair 50 are aligned in the axial direction and in contact with the inner circumferential surface of the circumferential wall part 14a.

As shown in FIG. 2 in an enlarged manner, a first annular groove 51a and a second annular groove 51b are formed to be spaced from each other in the axial direction of the stator holder 30 at positions on both sides in the axial direction of the outer circumferential surface of the stator holder 30. The first seal member 50A is assembled to the first annular groove 51a. The second seal member 50B is assembled to the second annular groove 51b. A recess part 52 having an annular shape is formed along an outer circumference of the stator holder 30 on the outer circumferential surface of the stator holder 30 between a formation part of the first annular groove 51a and a formation part of the second annular groove 51b.

The seal pair 50 (the first seal member 50A and the second seal member 50B) assembled to one end part side in the axial direction of the stator holder 30 is in close contact with the inner circumferential surface of the circumferential wall part 14a in a region (hereinafter, referred to as a “first region A1”) close to one end part in the axial direction of the circumferential wall part 14a of the housing 14. The seal pair 50 (the first seal member 50A and the second seal member 50B) assembled to another end part side in the axial direction of the stator holder 30 is in close contact with the inner circumferential surface of the circumferential wall part 14a in a region (hereinafter, referred to as a “second region A2”) close to another end part in the axial direction of the circumferential wall part 14a of the housing 14. The first seal member 50A regulates the leakage of the cooling liquid from the cooling liquid introduction room 32 to a lubricating liquid introduction room direction (a direction of the first lubricating liquid introduction room 43 or a direction of the second lubricating liquid introduction room 45). The second seal member 50B regulates the leakage of the lubricating liquid from the lubricating liquid introduction room (the first lubricating liquid introduction room 43 or the second lubricating liquid introduction room 45) to a cooling liquid introduction room 32 direction.

A recess part 53 having an annular shape is formed between a contact position of the first seal member 50A and a contact position of the second seal member 50B in the first region A1 and the second region A2 of the circumferential wall part 14a. A leakage liquid discharge hole 54 that radially penetrates through a wall of the circumferential wall part 14a is formed in a vertically lower region of the circumferential wall part 14a of the recess part 53 having an annular shape. The leakage liquid discharge hole 54 allows a bottom portion in the recess part 53 and the outside of the circumferential wall part 14a (the housing 14) to communicate with each other. The cooling liquid that is leaked through the first seal member 50A from the cooling liquid introduction room 32 is discharged out of the circumferential wall part 14a via the leakage liquid discharge hole 54 and the recess part 53. Similarly, the lubricating liquid that is leaked through the second seal member 50B from the first lubricating liquid introduction room 43 or the second lubricating liquid introduction room 45 is discharged out of the circumferential wall part 14a via the leakage liquid discharge hole 54 and the recess part 53.

A bottom lid 55 is attached to a lower surface of the circumferential wall part 14a (the housing 14). A leakage liquid flow-in room 56 is formed between the bottom lid 55 and the lower surface of the circumferential wall part 14a. A leakage liquid (the cooling liquid or the lubricating liquid) discharged out of the circumferential wall part 14a (the housing 14) through the leakage liquid discharge hole 54 flows into the leakage liquid flow-in room 56. The bottom lid 55 is detachably attached to the lower surface of the circumferential wall part 14a by a bolting or the like. A sensor 57 for detecting the flow-in of the leakage liquid is arranged in the leakage liquid flow-in room 56. The sensor 57 is connected to an input part of a control circuit (not shown). The control circuit is, for example, electrically connected to an alarm display lamp and turns on the alarm lamp when the sensor 57 detects that the leakage liquid has flowed in the leakage liquid flow-in room 56.

In the rotary electric machine 10 of the present embodiment, the heat of the stator 11 due to the heat generation of the coil 17 is cooled by the cooling liquid through the stator holder 30 by the introduction of the cooling liquid into the cooling liquid introduction room 32 in the housing 14. Further, by the introduction of the lubricating liquid into the first lubricating liquid introduction room 43 and the second lubricating liquid introduction room 45 in the housing 14, the lubrication required area such as the bearing 9 in the housing 14 is lubricated, and the rotor 12, the coil end 17e of the stator 11, or the like is cooled by the lubricating liquid.

Further, a space between the inner surface of the circumferential wall part 14a of the housing 14 and the outer circumferential surface of the stator holder 30 is sealed by the seal pair 50 constituted of the first seal member 50A and the second seal member 50B in the first region A1 and the second region A2. Thereby, the mutual inflow of the cooling liquid and the lubricating liquid between the cooling liquid introduction room 32 and the first lubricating liquid introduction room 43 and between the cooling liquid introduction room 32 and the second lubricating liquid introduction room 45 is regulated.

As described above, in the rotary electric machine 10 according to the present embodiment, the first seal member 50A which regulates the leakage of the cooling liquid from the cooling liquid introduction room 32 and the second seal member 50B which regulates the leakage of the lubricating liquid from the first lubricating liquid introduction room 43 or the second lubricating liquid introduction room 45 are provided inside the housing 14, and the leakage liquid discharge hole 54 communicates between the first seal member 50A and the second seal member 50B. Therefore, in the rotary electric machine 10 of the present embodiment, when the leakage of the cooling liquid or the lubricating liquid occurs at the first seal member 50A part or the second seal member 50B part, the leakage liquid can be discharged through the leakage liquid discharge hole 54 to the outside of the housing 14.

Accordingly, when the rotary electric machine 10 according to the present embodiment is employed, the leakage liquid discharged to the outside of the housing 14 through the leakage liquid discharge hole 54 is checked visually by an operator, by the sensor 57, or the like, and thereby, it is possible to detect the leakage of the cooling liquid or the lubricating liquid at an early stage.

Further, in the rotary electric machine 10 according to the present embodiment, the stator 11 is held inside the circumferential wall part 14a of the housing 14, the rotor 12 is arranged radially inside the stator 11 and coaxially with the stator 11, the cooling liquid introduction room 32 is arranged between the circumferential wall part 14a and the stator 11, and the first lubricating liquid introduction room 43 and the second lubricating liquid introduction room 45 are arranged inside the circumferential wall part 14a and axially outside the stator 11. Therefore, it is possible to efficiently cool a heat generating area inside the housing 14 by the cooling liquid flowing in the cooling liquid introduction room 32 and the lubricating liquid flowing inside the first lubricating liquid introduction room 43 and the second lubricating liquid introduction room 45.

Further, in the rotary electric machine 10 according to the present embodiment, the first seal member 50A is arranged at a position close to the cooling liquid introduction room inside the circumferential wall part 14a, the second seal member 50B is arranged at a position close to the lubricating liquid introduction room inside the circumferential wall part 14a, and the leakage liquid discharge hole 54 radially penetrates through the lower position of the circumferential wall part 14a. Therefore, the leakage of the cooling liquid is regulated by the first seal member 50A at the inner side of the circumferential wall part 14a, and the leakage of the lubricating liquid is regulated by the second seal member 50B at the inner side of the circumferential wall part 14a. In a case where the cooling liquid or the lubricating liquid is leaked from the first seal member 50A or the second seal member 50B, the leaked liquid is promptly discharged to the outside of the housing 14 from the leakage liquid discharge hole 54 that radially penetrates through the lower position of the circumferential wall part 14a.

Accordingly, when the rotary electric machine 10 according to the present embodiment is employed, it is possible to efficiently cool the inside of the housing 14, and it is possible to further promptly detect the leakage of the cooling liquid or the lubricating liquid.

Further, in the rotary electric machine 10 according to the present embodiment, the first seal member 50A and the second seal member 50B are arranged to be axially aligned and in contact with the inner circumferential surface of the circumferential wall part 14a. Therefore, when the present configuration is employed, a seal part structure formed of the first seal member 50A and the second seal member 50B is simplified, and it is possible to reduce the size of the rotary electric machine 10 and manufacturing costs.

Further, in the rotary electric machine 10 according to the present embodiment, the stator holder 30 is held in contact with the inner circumferential surface of the circumferential wall part 14a, and the stator holder 30 and the circumferential wall part 14a constitute the cooling liquid introduction room 32. The first seal member 50A and the second seal member 50B are arranged in contact with the inner circumferential surface of the circumferential wall part 14a and the outer circumferential surface of the stator holder 30. Therefore, by assembling the stator holder 30 to the circumferential wall part 14a of the housing 14 by a press fit or the like in a state where the stator 11 is attached to the stator holder 30, the first seal member 50A and the second seal member 50B can be easily arranged between the stator holder 30 and the circumferential wall part 14a.

Further, in the rotary electric machine 10 according to the present embodiment, the seal pair 50 constituted of the first seal member 50A and the second seal member 50B is arranged in the first region A1 and the second region A2 of the circumferential wall part 14a, and the leakage liquid discharge hole 54 is provided in each of the first region A1 and the second region A2. Therefore, it is possible to detect the leakage of the cooling liquid or the lubricating liquid at an early stage in the first region A1 and the second region A2 on both sides in the axial direction of the circumferential wall part 14a.

Further, in the rotary electric machine 10 according to the present embodiment, the leakage liquid flow-in room 56 that communicates with each leakage liquid discharge hole 54 in the first region A1 and the second region A2 is provided outside the housing 14, and the sensor 57 that detects an incoming leakage liquid is arranged inside the leakage liquid flow-in room 56. Therefore, when the leakage of the cooling liquid or the lubricating liquid occurs in either the first region A1 or the second region A2, the sensor 57 detects the leakage liquid that flows into the leakage liquid flow-in room 56 through the leakage liquid discharge hole 54, and thereby, it is possible to detect the leakage of the cooling liquid or the lubricating liquid at an early stage.

The present invention is not limited to the embodiment described above, and various design changes can be made without departing from the scope of the invention.

What is claimed is:

1. A rotary electric machine comprising:
a stator;
a rotor that is rotated relative to the stator;
a housing that is configured to accommodate the stator and the rotor;
a cooling liquid introduction room which is provided inside the housing and to which a cooling liquid for cooling a heat generation part is introduced; and
a lubricating liquid introduction room which is provided inside the housing and to which a lubricating liquid for lubricating a lubrication required area is introduced, the rotary electric machine further comprising:
a first seal member that is configured to regulate a leakage of the cooling liquid to a lubricating liquid introduction room direction from the cooling liquid introduction room;
a second seal member that is configured to regulate a leakage of the lubricating liquid to a cooling liquid introduction room direction from the lubricating liquid introduction room; and
a leakage liquid discharge hole which is arranged between the first seal member and the second seal member and which is configured to discharge the cooling liquid that is leaked through the first seal member and the lubricating liquid that is leaked through the second seal member to an outside of the housing.

2. The rotary electric machine according to claim 1,
wherein the stator is held inside a circumferential wall part of the housing,
the rotor is arranged radially inside the stator and coaxially with the stator,
the cooling liquid introduction room is arranged between the circumferential wall part and the stator,
the lubricating liquid introduction room is arranged inside the circumferential wall part and axially outside the stator,
the first seal member is arranged at a position close to the cooling liquid introduction room inside the circumferential wall part,
the second seal member is arranged at a position close to the lubricating liquid introduction room inside the circumferential wall part, and
the leakage liquid discharge hole is formed to radially penetrate through a lower position of the circumferential wall part.

3. The rotary electric machine according to claim 2,
wherein the first seal member and the second seal member are arranged to be axially aligned and in contact with an inner circumferential surface of the circumferential wall part.

4. The rotary electric machine according to claim 3, further comprising:
a stator holder that has a substantially cylindrical shape and that holds the stator at an inner circumferential side,
wherein the stator holder is held in contact with an inner circumferential surface of the circumferential wall part,
the stator holder and the circumferential wall part constitute the cooling liquid introduction room, and
the first seal member and the second seal member are arranged in contact with the inner circumferential surface of the circumferential wall part and an outer circumferential surface of the stator holder.

5. The rotary electric machine according to claim 2,
wherein a seal pair constituted of the first seal member and the second seal member is arranged in a first region close to one end portion in an axial direction of the circumferential wall part and a second region close to another end portion in the axial direction of the circumferential wall part, and
the leakage liquid discharge hole is provided in each of the first region and the second region.

6. The rotary electric machine according to claim 5,
wherein a leakage liquid flow-in room that communicates with the leakage liquid discharge hole is provided outside the housing, and
a sensor that is configured to detect an incoming leakage liquid is arranged in the leakage liquid flow-in room.
